(19) United States
(12) Patent Application Publication
(10) Pub. No.: US 2007/0074668 A1
(43) Pub. Date: Apr. 5, 2007

(54) Animal training device

(76) Inventors: Cerena W. Zutis, San Mateo, CA (US); Diana L. Gerba, Los Gatos, CA (US)

Correspondence Address: SCHNECK & SCHNECK, P.O. BOX 2-E, SAN JOSE, CA, 95109-0005, US

(21) Appl. No.: 11/633,913

(22) Filed: Dec. 5, 2006

Related U.S. Application Data
(63) Continuation of application No. 11/218,360, filed on Sep. 2, 2005.

(51) Int. Cl. A01K 5/00

(52) U.S. Cl. 119/51.01

(57) ABSTRACT

An animal training device includes a housing defining an internal compartment, a noise producing element with the housing, a tray extending from the front of the housing and a button. Pressing the button dispenses a food treat from the compartment and causes the noise producing element to emit a noise.

### CROSS-REFERENCE TO RELATED APPLICATION

This is a continuation of pending U.S. patent application Ser. No. 11/218,360 filed Sep. 2, 2005.

### TECHNICAL FIELD

This invention relates to a device for animal training. More specifically the invention provides a device for animal training using positive reinforcement.

### BACKGROUND ART

Animal training is a popular past time for animal owners. This activity, in addition to providing a hobby for animal owners also provides an opportunity to shape the behavior of the animal to accommodate the owner's needs. Two common techniques for animal training are positive reinforcement and punishment based training. Punishment training uses punishment to shape behavior. This technique can lead to animal aggression and may cause an animal to fear training or the trainer. In contrast, positive reinforcement rewards desired behavior. The animal, upon receiving the reward, associates the desired behavior with the positive reinforcing reward. This increases the probability that the behavior will be repeated. Such behaviors can then be associated with a command (such as sit, stay or down for dog training) allowing the behavior to be recalled on a cue.

One common method of reward-based training is “click and reward”. In click and reward training a distinctive sound (such as a metallic click) made by a toy clicker is used as a signal to shape behavior. The instant a desired behavior is observed the click is sounded rapidly followed by giving a reward (usually a small food reward) to the animal. The clicking sound serves as a marker to indicate immediately to the animal that the animal's behavior is the desired behavior and also serves as a “bridge” between the desired behavior and the reward. Under this click and reward system the food serves as a primary reward with the click or other sound serving as a secondary reinforcer for the desired behavior.

The current method of click and reward training requires the trainer to have a sound producing device (such as a clicker) in one hand and a reward (such as a food treat) in the other hand. This allows the trainer to give the animal the food treat shortly after clicking the clicker to indicate to the animal that the correct behavior has been performed. This requires use of both the trainer's hands. This may be awkward if the animal is on a leash or if one of the trainer's hands is otherwise occupied. In animal training, a hand signal may be used in place of or in addition to a spoken command. Such hand signals are required if the animal is deaf. If hand signals are used, keeping one hand free is required. Presently, a number of small, inexpensive clicker devices are sold. In addition, some prior sound producing small item dispensers are known. For example. U.S. Pat. No. 6,267,639 to Menow et al. discloses an elongate candy dispenser having a decorative moving display and a sound emitting element. The candy is dispensed into one of the user's hands while the other hand holds the dispenser.

It is an object of the invention to provide a training device that allows a trainer with one hand to both generate a sound and to provide a reward accessible to an animal being trained.

### SUMMARY OF THE INVENTION

The above objects are achieved using a hand held device for training animals. The device includes a housing including an internal compartment for retaining a store of treats. The store of treats may be discreet small individual treats (e.g. dog kibble or other pellet-style rewards) or could be an elongate section of treats or a aerosol dispensed food canister. Also within the housing is a sound producing element such as a clicker. Extending from the housing is a tray. This tray is smaller than the housing but sufficiently large such that it can catch and hold a treat dispensed from the housing. The tray is not covered to allow an animal to able to access the treat once it is dispensed. A button also extends from the housing. When a user depresses the button this causes the sound producing element to make a sound and also dispenses a treat from the treat retaining compartment onto the tray. By using this device the primary reward may be dispensed onto the tray while the secondary indicator is simultaneously activated. This reduces the time between the giving of the bridge signal indicating to an animal that a correct behavior has been performed and the subsequent providing of the reward to the animal.

The treat retaining compartment may include a device for positioning the treats with the compartment. A spring biased backing could ensure that the treats are properly dispensed. The device may also include a blade within the housing such that pressing the button also moves the blade against an elongate treat section such that a small segment of the treat section is sliced off and dispensed from the housing onto the treat retaining tray. In this way an elongate soft treat such as an elongate cylinder of string cheese or other similar treat may be used with the device. Alternatively the housing could contain an propellant dispersed treat dispenser such as a propellant dispelled cheese or meat product. The button of the device would press against a nozzle or button of the aerosol treat dispenser. Dispensing a small amount of treat from the aerosol container. The device may also have the tray retracted so that when not in use it has more compact storage.

### BRIEF DESCRIPTION OF THE DRAWINGS

FIG. 1 is a cross section of a first embodiment of the present invention.

FIG. 2 is a cross section of FIG. 1 after a treat has been dispensed.

FIG. 3 is a cross section of an alternative embodiment of the present invention in which the treat is a sliceable elongate section.

FIG. 4 is the cross section of FIG. 3 after a segment has been sliced off of the treat section.

FIG. 5 is a cross sectional view of an alternative embodiment showing an alternate way for treats to be dispensed.

FIG. 6 is a cross section of FIG. 5 after a treat has been retained within the treat dispensing device.

FIG. 7 is a cross section of FIG. 5 showing the treat moving to the dispensing tray.

FIG. 8 is a cross section of another alternative embodiment in which a propellant dispensed treat holding container is used.

FIG. 9 is the cross section of FIG. 8 as a treat is dispensed.

FIG. 10 is a cross section of another alternate embodiment.

FIG. 11 is the cross section of FIG. 10 as a treat is dispensed.

### BEST MODE FOR CARRYING OUT THE INVENTION

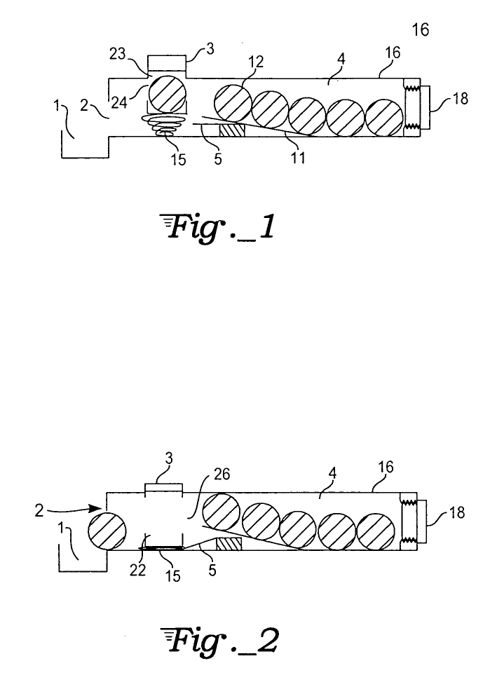

With reference to FIG. 1 an exterior housing 16 encloses an interior space for holding treats 12. Treats 12 are a roughly uniformed sized animal treat reward (such as dog kibble or other food treat item). A track 11 positioned the food treats within a treat retaining compartment 4. A backing 18 or housing 16 may be removed allowing additional treats to be added to treat retaining compartment 4. Extending from the front of housing 16 is treat holding tray 1. Tray 1 may be attached on a pin 9 to housing 16 such that the tray may rotate behind the housing. The housing, as used herein, is defined a palm sized or smaller casing having an interior space. The housing and button may be made of a variety of materials, including molded plastic. The housing may have a generally rectangular shape.

Contained within housing 16 is a sound producing element 5. Sound producing element 5 may be any element which produces a distinctive sound loud enough for an animal to hear and distinguish the sound. A dimpled metal sheet secured at one end to a fixed mount is one inexpensive and easily manufactured sound producing element. A number of alternatives including electronic sound producing devices may be used.

A button 3 extends from housing 16. An interior compartment 22 within button 3 has an entrance opening 26 and a exit opening 24. When button 3 is depressed two actions are carried out. First, a treat 12 within interior space 22 on button 3 moves through opening 24 and out housing 16 through opening 2 into tray 1. This is illustrated in FIG. 2. At the same time a corner of button 3 presses down upon sound producing element 5. When sound producing element 5 is bent a clicking sound is made. When button is released, spring 15 returns button 3 to its original position. In this position treat 12 may enter compartment 22 through opening 26.

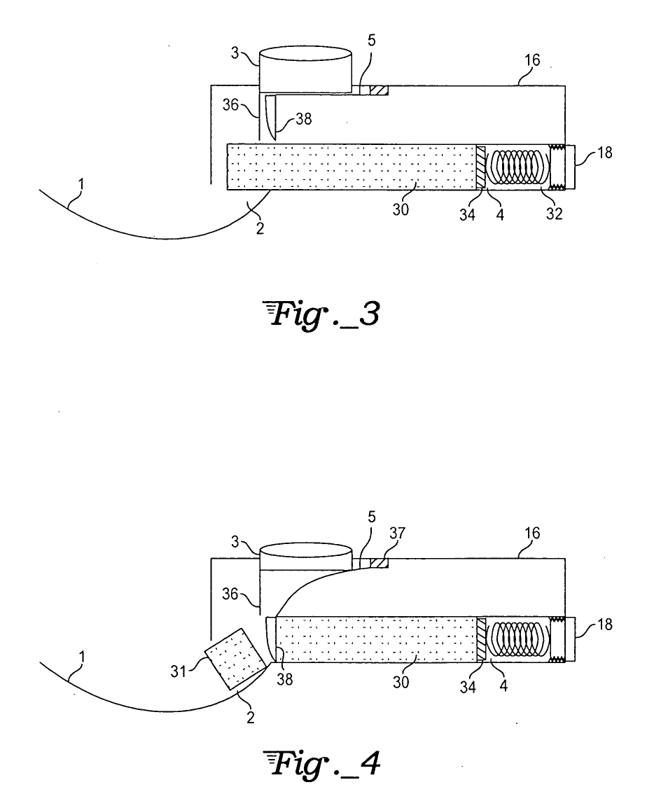

An alternative embodiment is illustrated in FIG. 3. Again a housing 16 includes an interior compartment 4. At the rear of interior compartment 4 is a replaceable cover 18 allowing access to interior compartment 4. A slideable backing 34 is spring-biased against the end of the compartment by a spring 32. Backing 34 presses against a treat section 30. A treat section 30 may be a elongate cylinder of a relatively soft treat such as a section of cheese or soft compressed meat product. Also within housing 16 is a sound producing element 5. This is held by end brace 37 which is secured onto the sides of housing 16. Extending from the end of sound producing element 5 is a blade 38. In this embodiment button 3 includes a pin 36 extending from the bottom of button 3. As shown in FIG. 4 when button 3 is depressed the sound producing element 5 is bent producing a sound. This also causes blade 38 on sound producing element 5 to slice through a section of the elongate treat section 30 cleaving off a individual treat segment 31. The pin 36 extending from the bottom of button 3 holds treat section 30, allowing an individual treat segment to be sliced off. This treat section then leaves housing 16 through opening 2 and falls onto tray 1.

The placement of the blade allows for cutting the treat section. The knife could be on button 3, or could be on housing 16, extending from below the treat section. In this configuration, the button would press the treat into the knife.

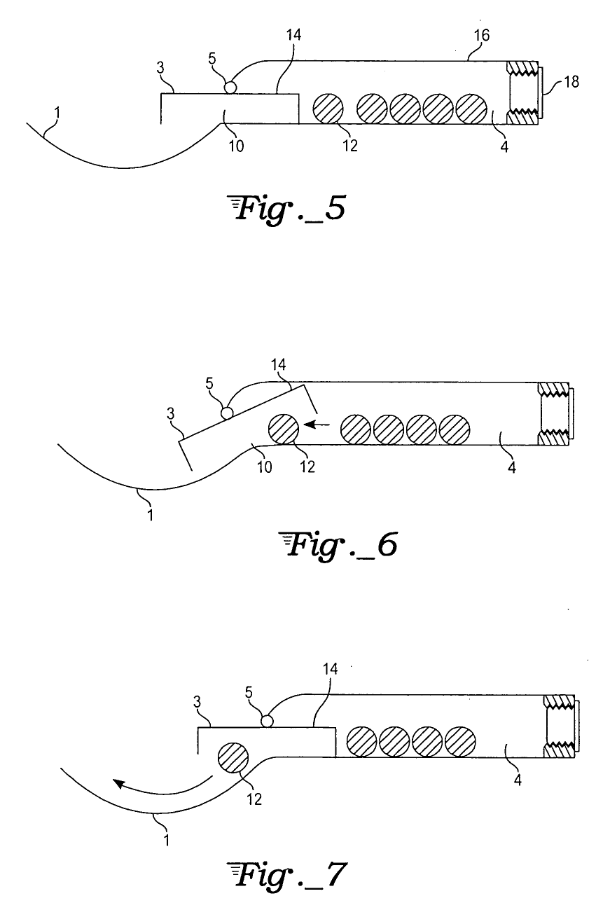

FIGS. 5, 6, and 7 show another embodiment of the present invention. Again housing 16 defines an interior cavity 4 holding discreet units of food 12. A removable cap 18 at the end of the housing 16 allows additional food to be added into food containers 4. The device is activated by pressing button 3. This causes sound producing element 5 to make a sound and raises end 14 allowing treat 12 to move within a dispensing location 70. Sound producing element 5 may be a section of housing 16 that produces a sound when bent. This is shown in FIG. 6. FIG. 7 shows the release of button 3 where end 14 lowers an treat 12 is then able to move into tray 1.

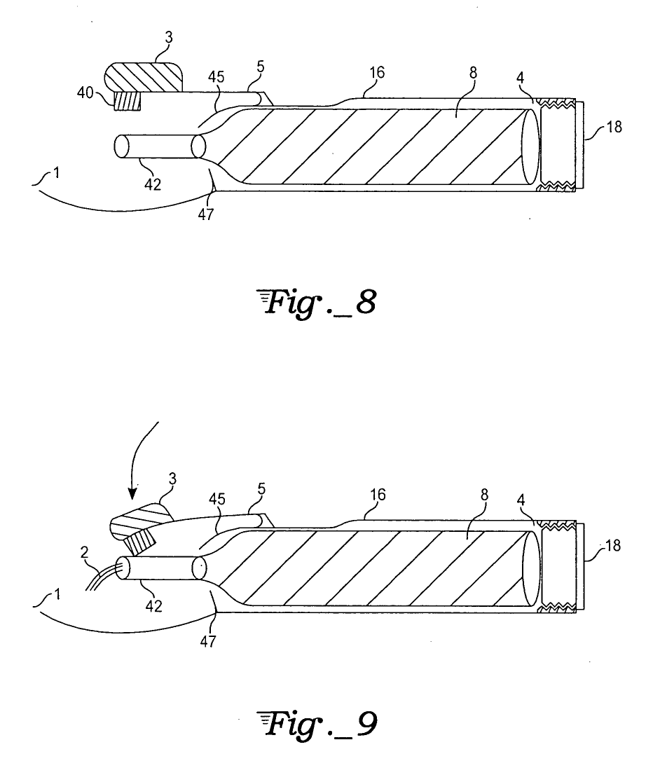

FIGS. 8 and 9 are cross section of another alternative embodiment. Again, housing 16 has an internal compartment 4 having an end cap 18 which is removable allowing access to internal compartment 4. In this case within internal compartment 4 is a propellant dispensed treat container 8. The front of treat container 8 is retained by flanges 45, 47 extending from housing 16. Cap 18 is sealed to enclose container 8 in compartment 4. Container 8 may hold a spreadable meat or a cheese product. Such products are generally dispensed by bending the dispense nozzle 42 of the treat container 8. In this embodiment mounted on housing 16 is button 3 mounted on sound producing element 5. Extending from the front of button 3 is tooth 40. When button 3 is pressed sound producing element 5 is bent producing a sound. In addition protrusion 40 contacts nozzle 42 causing the discreet treat 2 to be dispensed into tray 1, as shown in FIG. 9.

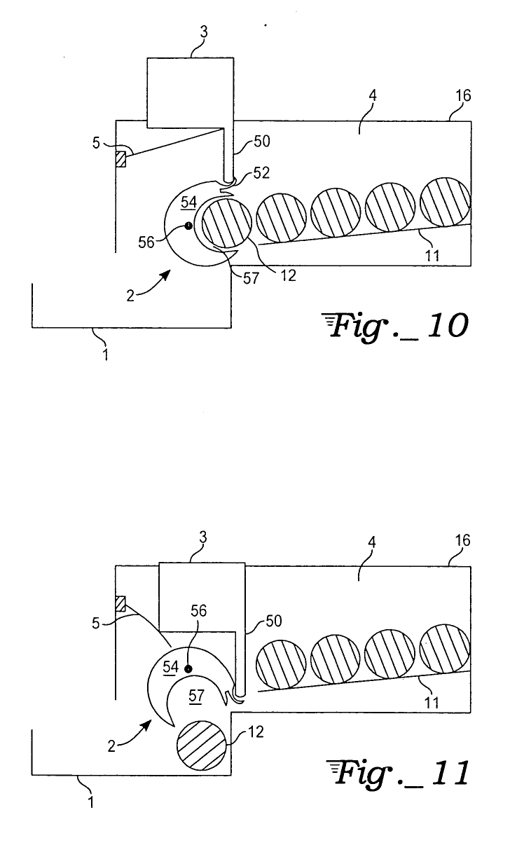

Another alternate embodiment is shown in FIGS. 10 and 11. As before, a housing 16 contains animal treats 12 held on track 11 in a compartment 4. A button 3 extends from housing 16. Secured to housing 16 is a sound producing element 5 that presses against button 3.

Tooth 50 extends from button 3. Tooth 50 presses against tooth 52 on cylinder 54. Cylinder 54 is mounted on hub 56 secured to housing 16 such that cylinder 54 can rotate. When button 3 is pressed, as shown in FIG. 11, tooth 50 pushes down on tooth 52, causing cylinder 54 to rotate on hub 56. Treat 12 held in a cavity 57 is rotated to a location where the treat can move onto tray 1 through opening 2. At the same time button 3 bends sound producing element 5, producing a sound.

When button 3 is released, element 5 returns the button to its original position. Cylinder 54 may either be spring biased or mechanically joined to button 3 such that cylinder 54 returns to the position shown in FIG. 10 and another treat fills cavity 57 from track 11.

In any of the embodiments, the tray is defined as a surface able to hold a dispensed treat. The tray is also defined as a surface from which an animal could take a treat as soon as the treat is dispensed. Tray 1 extends from the housing and is not covered.

In any of the embodiments, some rearrangements of the elements is possible. For example, button 3 may be spring biased or could be otherwise mounted on housing 16. A flange of tapered shape of button 3 could be used to retain button 3 in a hole in housing 16. Alternatively button 3 could be an electronic switch and both the noise generator and treat dispenser could be electronic.

In any of the embodiments, the housing is sufficiently small to be held in one hand. As the button is pressed in response to an animal performing a desired behavior, a sound will be immediately produced and the treat will be dispersed into the tray. The tray may then be brought to where the animal can reach it with the animal's mouth.

1. A method for dispensing treats during animal training of animals owned by an animal owner, comprising:
a) holding in a first trainer hand a click and treat dispenser;
b) actuating a button on said click and treat dispenser, said button causing a sound to be produced and a treat to be dispensed into a compartment on said dispenser, wherein step b includes a step selected from a group consisting of (i) actuating a button which depresses a self-contained propellant dispensed treat container, and (ii) slicing a treat from an elongate treat section.

2. The method of claim 1, wherein step b includes causing a sound to be produced by bending a bendable sound producing element.

3. The method of claim 1, further comprising continuously biasing the treat in the dispenser until the treat is dispensed.

4. A dog training method comprising:
a) prompting a dog to perform a behavior;
b) actuating a button on a click and treat dispenser upon observation of the behavior, said actuating causing a sound to be produced and simultaneously a treat to be dispensed into an open top compartment on said dispenser such that said treat is retained with said compartment such that said treat may be removed by the dog, wherein step b includes a step selected from a group consisting of (i) actuating a button which depresses a self-contained propellant dispensed treat container, and (ii) slicing a treat from an elongate treat section.

5. The dog training method of claim 4, wherein step a includes giving a hand signal.

6. The method of claim 4, wherein step b includes causing a sound to be produced by bending a bendable sound producing element.
